(19) United States
(12) Patent Application Publication
(10) Pub. No.: US 2018/0160191 A1
(43) Pub. Date: Jun. 7, 2018

(54) METHOD FOR CONTENT DIRECTORY SERVICE BUILDING WITH AUTHORIZED LIVE CHANNELS

(71) Applicant: ARRIS Enterprises LLC, Suwanee, GA (US)

(72) Inventor: Venkatesh Prabu Mahadevan, Horamaru (IN)

(21) Appl. No.: 15/366,542

(22) Filed: Dec. 1, 2016

(51) Int. Cl. H04N 21/6334; H04N 21/482

(52) U.S. Cl. CPC H04N 21/6334; H04N 21/4823

(57) ABSTRACT

Various implementations described herein are directed to technologies for providing content directory service building with authorized live channels. A content directory service is provided by a set top box for a plurality of live channels. An authorization list that includes an authorization status of each of the plurality of live channels is provided. The set top box updates the content directory service to exclude unauthorized live channel information and include authorized live channel information based on the authorization list.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

In a Digital Living Network Alliance (DLNA) network, the set top box (STB) acts as a Digital Media Server (DMS) and showcases its content as a Content Directory Service (CDS). The CDS contains the list of all live channels apart from different content types, e.g., recoded audio/video, image content, audio only content, etc.

Presently, the authorization state of a live channel is known in the prior art only after tuning to that channel. Thus, the CDS of the STB includes all of the live channels, which includes authorized content and unauthorized content. This situation is both confusing to the user and promotes user dissatisfaction because the user is only able to play authorized channels but may attempt to play unauthorized channels that are not playable from the Digital Media Player (DMP) associated with the DMS.

### SUMMARY

Described herein are implementations of various technologies of a method for providing content directory service building with authorized live channels. A content directory service is provided by a set top box for a plurality of live channels. An authorization list that includes an authorization status of each of the plurality of live channels is provided. The set top box updates the content directory service to exclude unauthorized live channel information and include authorized live channel information based on the authorization list.

The authorization list may be a data structure. The authorization list may include a virtual channel number or service ID and a corresponding channel authorization status. In one implementation, an authorization status for each channel in the authorization list may be a flag. In another implementation, an authorization status for each channel in the authorization list may be a bit array.

The authorization list may be provided by background tapping an available tuner of the set top box. The available tuner is used to retrieve channel authorization information. Audio and/or video presentation may be disabled for the available tuner when channel authorization information is acquired. Channels may be tuned one-by-one without configuring audio and/or video packet identifiers for presentation and/or decoding. The available tuner may be released when the available tuner is required by the set top box for a different purpose.

The authorization list may be received from a head end. The authorization list may be received from the head end upon boot up of the set top box.

In one implementation, the authorization list may be an authorization list private carousel. The authorization list private carousel may be all live channel virtual channel number and service identifiers. The authorization list private carousel may include authorization statuses for each channel. The authorization list private carousel may include section data with a separate packet identifier value.

The authorization list private carousel may be existing metadata. The existing metadata may be a private descriptor of a virtual channel table.

Also described herein are implementations of various technologies of a device for providing content directory service building with authorized live channels. The device includes a set top box. The set top box may be configured to: provide a content directory service for a plurality of live channels; provide an authorization list that includes an authorization status of each of the plurality of live channels; and update the content directory service to exclude unauthorized live channel information and include authorized live channel information based on the authorization list.

Further described herein are implementations of various technologies of a non-transitory computer-readable medium having stored thereon a plurality of computer-executable instructions which, when executed by a computer, cause the computer to: provide, by a set top box, a content directory service for a plurality of live channels; provide an authorization list that includes an authorization status of each of the plurality of live channels; and update, by the set top box, the content directory service to exclude unauthorized live channel information and include authorized live channel information based on the authorization list.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates an example network environment in accordance with implementations of various techniques described herein.

FIG. 2 illustrates an example set top box in accordance with implementations of various techniques described herein.

FIG. 3 illustrates a flow diagram of a method for providing content directory service building with authorized live channels in accordance with implementations of various techniques described herein.

FIG. 4 illustrates a flow diagram of a method for providing background tapping in accordance with implementations of various techniques described herein.

FIG. 5 illustrates a schematic diagram of a computing system in which the various technologies described herein may be incorporated and practiced.

### DETAILED DESCRIPTION

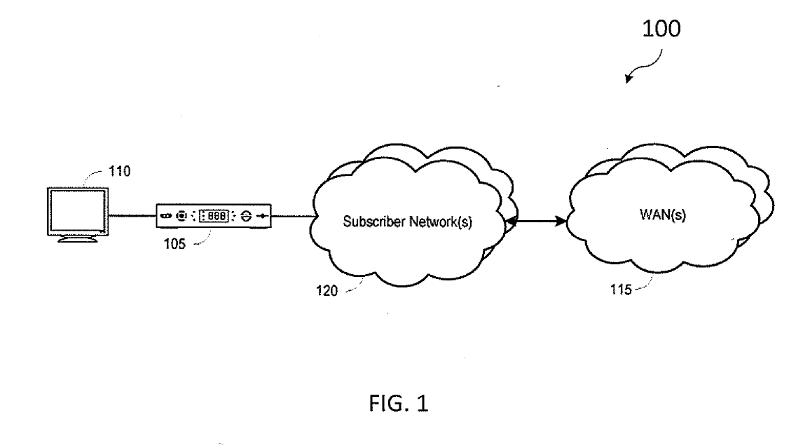

One or more implementations of various techniques for providing content directory service building with authorized live channels will now be described in more detail with reference to FIGS. 1-5 in the following paragraphs.

FIG. 1 is a block diagram illustrating an example network environment 100 for providing content directory service building with authorized live channels. In some implementations, video, voice, and/or data services may be delivered to one or more client devices via one or more customer premise equipment (CPE) devices installed within a subscriber premise. For example, multiple services may be provided by a set-top box (STB) 105 and may be received by a user through a display device (e.g., television 110). It should be understood that a user may receive multiple services through other display devices such as a mobile device, tablet, computer, gaming console, and others. The various data, multimedia, and/or voice services provided by the STB 105 may include, but is not limited to, live or broadcast television, video-on-demand (VoD) content, pay-per view content, recorded content (e.g., DVR content), audio-only content, streaming content, and others. A set-top box (STB) may receive content from multiple different networks and/or service providers and store this content in a memory. In one implementation, STB 105 may act as a digital media server in a DLNA-based network.

Multiple services may be delivered to CPE devices over one or more local networks. For example, a local network may be provided by a gateway device, and the multiple services may be delivered to one or more CPE devices by the gateway device. Local network(s) may include a coaxial network, a local area network (LAN), wireless local area network (WLAN), personal area network (PAN), Multimedia over Coax Alliance (MoCA) network, mobile hotspot network, and others. It should be understood that the STB 105 may receive services from and may output upstream communications to an access point (e.g., gateway device, modem, router, wireless extender, etc.) over a wired or wireless connection to the access point.

Multiple services may be delivered to a subscriber premise from a wide-area network (WAN) 115 through a subscriber network 120. The subscriber network 120 may include, for example, a hybrid fiber-coaxial (HFC) network, fiber network, mobile network, satellite network, and any other network operable to deliver services to a subscriber premise.

Multimedia content may be received at the STB 105 as a content stream. For example, the content may be delivered to the STB 105 as a stream of packets or frames, and the packets or frames may be decoded and processed for presentation to a user through a connected display device (e.g., television 110).

The STB 105 may be configured to receive content from a plurality of content or service providers. For example, the STB 105 may receive content from a plurality of different subscriber networks 120 (e.g., a head end of a cable network, satellite network, etc.) and/or WANs 115. Content streams received from different service providers may be received at the STB 105 in different formats.

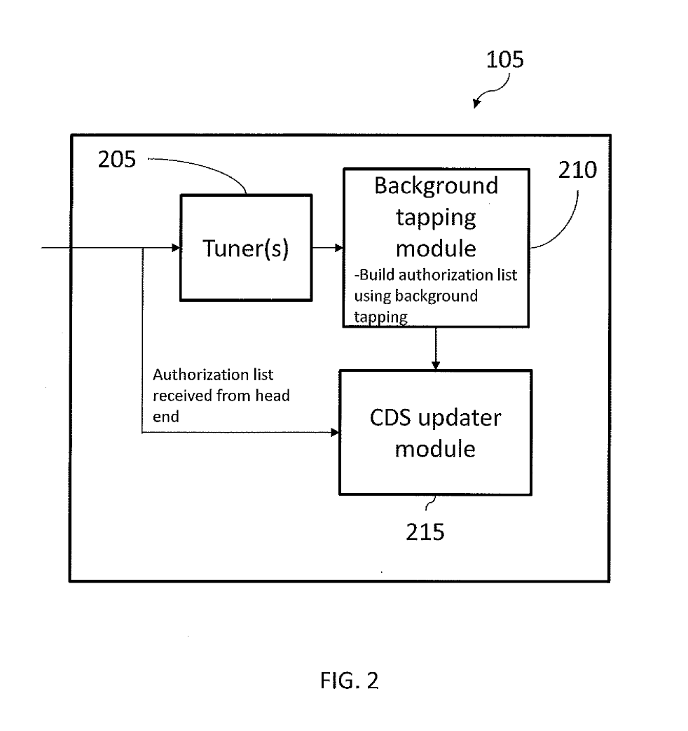

FIG. 2 is a block diagram illustrating an example set-top box (STB) 105 operable to build a content directory service (CDS) by excluding unauthorized channels and including authorized/playable live channels in the CDS using channel authorization information in accordance with various implementations described herein. The STB 105 may include one or more tuner(s) 205, a background tapping module 210, and a CDS updater module 215.

Multimedia content may be received at the tuner 205. For example, multimedia content may be received at the tuner 205 from an upstream network (e.g., a head end in subscriber network 120 of FIG. 1) as a content stream (e.g., Internet protocol (IP) stream, MPEG stream, etc.). The tuner 205 may decode the received content stream and process the content for output to a display device (e.g., television 110 of FIG. 1) through the display interface 210. It should be understood that content streams may be received at the tuner 205 in a variety of formats and from a variety of content providers and/or networks. For example, the tuner 205 may receive content streams delivered to the STB 105 over a cable network and/or a satellite network.

The background tapping module 210 builds an authorization list using at least one available tuner. The background tapping method uses available tuners to retrieve channel authorization information. This functionality is available when using multi-tuner set top boxes. In this implementation, the authorization information is tapped in the background using an available tuner to tune to channels one-by-one without enabling the audio/visual presentation. Using an available tuner in the background allows background tapping to proceed without disturbing currently used/presenting tuners.

In order to avoid delay/dependency issues related to background tapping, a different implementation can be used to provide the authorization list. In this implementation an authorization list private carousel that includes channel authorization information is provided, e.g., from the head end.

The CDS updater module 215 receives the authorization list from either the background tapping module or the head end. The content directory service is updated to exclude unauthorized live channel information and include authorized live channel information based on the authorization list. As described above, the authorization list can be determined using the background tapping module or acquired from the head end.

In one implementation, when background tapping is not used, the set top box immediately acquires the authorization list, e.g., authorization list private carousel, from the head end upon boot up. Because the authorization list private carousel is provided by the head end immediately after the set top box boots up, the CDS list can be built/updated with only authorized channels quickly without being dependent upon tuner availability.

Once the authorization list is built completely or acquired from the head end, the authorization list can be used as a filter while constructing the CDS. In one implementation, constructing the CDS includes checking the authorization status for one of a plurality of channels from the authorization list (or authorization list private carousel). If the channel is authorized, the channel is included in the CDS list. If the channel is unauthorized, the channel is not included in the CDS list. The method continues for all of the live channels in the authorization list until the CDS list is built.

The present disclosure provides a method for building a content directory service (CDS) by excluding the unauthorized channels and including the authorized/playable live channels in the CDS using channel authorization information.

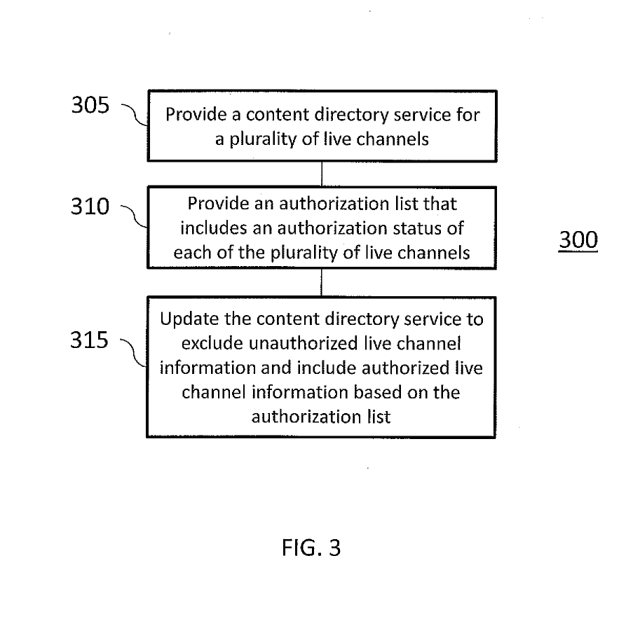

FIG. 3 illustrates a diagram of a method 300 for CDS service building with authorized live channels in accordance with implementations of various techniques described herein. At block 305 a content directory service for a plurality of live channels is provided.

At block 310 an authorization list that includes an authorization status of each of the plurality of live channels is provided.

In one implementation, the authorization list is determined by the set top box using a background tapping method. The background tapping method uses available tuners to retrieve channel authorization information. This functionality is available when using multi-tuner set top boxes. In this implementation, the authorization information is tapped in the background using an available tuner to tune to channels one-by-one without enabling the audio/visual presentation. Using an available tuner in the background allows background tapping to proceed without disturbing currently used/presenting tuners.

In one example, the set top box includes two tuners (Tuner-1, Tuner-2). Tuner-1 is already tuned to a channel and presenting audio and/or visual information. In this example, the status of Tuner-2 is available or in an unused. Tuner-2 can, thus, be used to acquire authorization information by tuning the channels one-by-one in the background. In this implementation, tuning of the channels one by one in the background is done in a way that the audio and/or video packet identifiers (PIDs) are not configured for presentation and/or decoding. By proceeding in the background in this manner, the active audio and/or video from Tuner-1 is not disturbed.

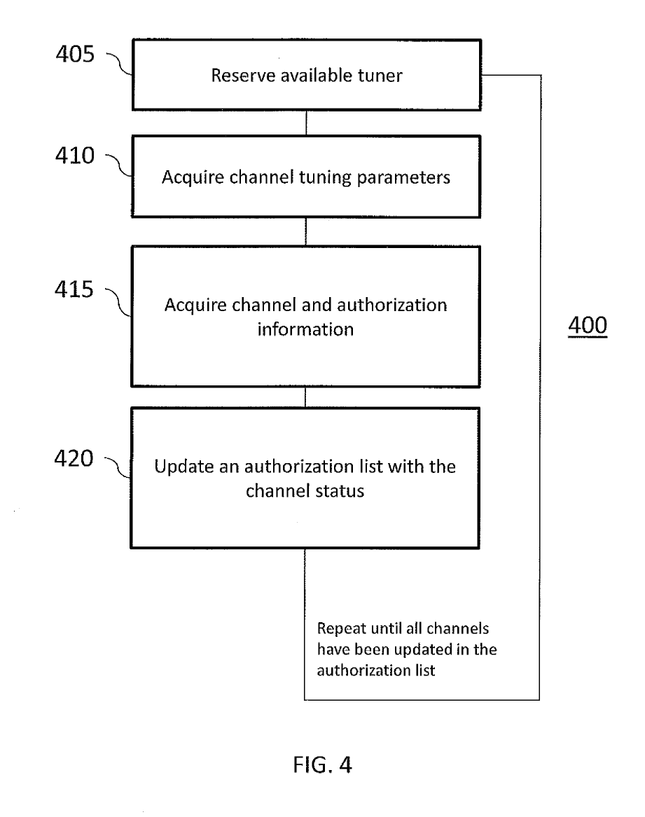

FIG. 4 illustrates a diagram of a method 400 for providing an authorization list using background tapping. At block 405, the set top box checks for an available tuner and reserves the available tuner. The reserved tuner may be released after using or may be released immediately when the tuner is required for a different or higher priority purpose.

At block 410, the tuning parameters of a first one of a plurality of channels are acquired. In one implementation, the tuning parameters are acquired from a virtual channel table received from the head end.

At block 415, the channel and authorization information for the channel are acquired using the available tuner. In one implementation, acquisition of the channel and authorization information may include locking the tuner and acquiring the authorization information. The authorization information may be available to the set top box as, for example, section data in transport stream packet for that present channel. In this implementation, acquisition of the channel and authorization information avoids configuring the audio, video or program clock reference (PCR) PIDs for decoding. In addition, acquisition of the channel and authorization information does not affect current active presentations, if any.

At block 420, an authorization list is updated with the status, e.g., authorized or unauthorized, of the current channel. In one implementation, the authorization list may be a data structure that includes the virtual channel number (VCN) or service ID and the corresponding authorization status. In one implementation, the authorization status may be a flag that contains TRUE if the channel is authorized and FALSE if the channel is unauthorized. In another implementation, the authorization status may be a BitArray to the size of the number of live channels available that contains a ‘1’ if the channel is authorized and a ‘0’ if the channel is unauthorized. Blocks 405, 410, 415 and 420 are repeated until all of the live channels have been updated in the authorization list.

Building the CDS may be delayed because the background tapping method of FIG. 4 is dependent on tuner availability. This delay/dependency issue can be overcome using a different implementation to provide the authorization list. In this implementation, an authorization list private carousel that includes channel authorization information is provided. In one implementation, the authorization list private carousel is provided by the head end. The authorization list private carousel is a data structure that is used similar to the authorization list described in the description of block 420 above. The authorization list private carousel includes the list of all live channel VCNs or Service IDs along with the authorization statuses for each channel. In one implementation, the authorization status may be a flag that contains TRUE if the channel is authorized and FALSE if the channel is unauthorized. In another implementation, the authorization status may be a BitArray to the size of the number of live channels available that contains a ‘1’ if the channel is authorized and a ‘0’ if the channel is unauthorized.

In one implementation, the authorization list is private carousel data from the head end as section data with a separate PID value. In another implementation, the authorization list is provided from the head end as part of existing metadata, e.g., of the virtual channel table (VCT), as a private descriptor.

Returning to FIG. 3, at block 315 the content directory service is updated to exclude unauthorized live channel information and include authorized live channel information based on the authorization list. As described above, the authorization list can be determined using a background tapping method or acquired from the head end.

In one implementation, the authorization list private carousel is obtained by acquiring the authorization list data, e.g., data structure and/or metadata, from the head end immediately after the set top box boots up. Because the authorization list private carousel is provided by the head end immediately after the set top box boots up, the CDS list can be built/updated with only authorized channels quickly without being dependent upon tuner availability.

Once the authorization list is built completely or acquired from the head end, the authorization list can be used as a filter while constructing the CDS. In one implementation, constructing the CDS includes checking the authorization status for one of a plurality of channels from the authorization list (or authorization list private carousel). If the channel is authorized, the channel is included in the CDS list. If the channel is unauthorized, the channel is not included in the CDS list. The method continues for all of the live channels in the authorization list until the CDS list is build. Using the techniques described in the present disclosure does not require any changes to the existing properties/parameters of the CDS list.

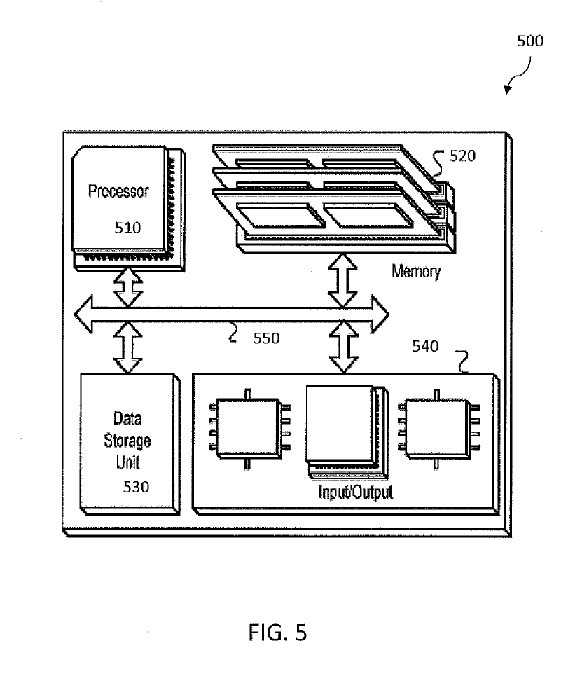

FIG. 5 is a block diagram of a hardware configuration 500 operable to build a content directory service (CDS) by excluding unauthorized channels and including authorized/playable live channels in the CDS using channel authorization information. The hardware configuration 500 can include a processor 510, a memory 520, a storage device 530, and an input/output device 540. Each of the components 510, 520, 530, and 540 can, for example, be interconnected using a system bus 550. The processor 510 can be capable of processing instructions for execution within the hardware configuration 500. In one implementation, the processor 510 can be a single-threaded processor. In another implementation, the processor 510 can be a multi-threaded processor. The processor 510 can be capable of processing instructions stored in the memory 520 or on the storage device 530.

The memory 520 can store information within the hardware configuration 500. In one implementation, the memory 520 can be a computer-readable medium. In one implementation, the memory 520 can be a volatile memory unit. In another implementation, the memory 520 can be a non-volatile memory unit.

In some implementations, the storage device 530 can be capable of providing mass storage for the hardware configuration 500. In one implementation, the storage device 530 can be a computer-readable medium. In various different implementations, the storage device 530 can, for example, include a hard disk device/drive, an optical disk device, flash memory or some other large capacity storage device. In other implementations, the storage device 530 can be a device external to the hardware configuration 500.

The input/output device 540 provides input/output operations for the hardware configuration 500. In one implementation, the input/output device 540 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video, voice, and/or data services to a display device (e.g., television 110 of FIG. 1, mobile device, tablet, computer, etc.). In embodiments, the input/output device can include driver devices configured to send communications to, and receive communications from one or more networks (e.g., local network, subscriber network 120 of FIG. 1, WAN 115 of FIG. 1, etc.).

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”, “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
providing, by a set top box, a content directory service for a plurality of live channels;
providing an authorization list that includes an authorization status of each of the plurality of live channels;
updating, by the set top box, the content directory service to exclude unauthorized live channel information and to include only authorized live channel information of the plurality of live channels based on the authorization list; and
providing the updated content directory service to a display.

2. The method of claim 1, wherein the authorization list comprises a data structure.

3. The method of claim 2, wherein the authorization list includes a virtual channel number or service ID and a corresponding channel authorization status.

4. The method of claim 2, wherein an authorization status for each channel in the authorization list comprises a flag.

5. The method of claim 2, wherein an authorization status for each channel in the authorization list comprises a bit array.

6. The method of claim 1, wherein the authorization list is provided by background tapping an available tuner of the set top box.

7. The method of claim 6, wherein the available tuner is used to retrieve channel authorization information.

8. The method of claim 6, wherein audio and/or video presentation is disabled for the available tuner when channel authorization information is acquired.

9. The method of claim 6, wherein the available tuner is released when the available tuner is required by the set top box for a different purpose.

10. The method of claim 1, wherein channels are tuned one-by-one without configuring audio and/or video packet identifiers for presentation and/or decoding.

11. The method of claim 1, wherein the authorization list is received from a head end.

12. The method of claim 11, wherein the authorization list is received from the head end upon boot up of the set top box.

13. The method of claim 1, wherein the authorization list comprises an authorization list private carousel.

14. The method of claim 13, wherein the authorization list private carousel comprises all live channel virtual channel number and service identifiers.

15. The method of claim 13, wherein the authorization list private carousel comprises authorization statuses for each channel.

16. The method of claim 13, wherein the authorization list private carousel comprises section data with a separate packet identifier value.

17. The method of claim 13, wherein the authorization list private carousel comprises existing metadata.

18. The method of claim 17, wherein the existing metadata comprises a private descriptor of a virtual channel table.

19. A device, comprising:
a set top box configured to:
provide a content directory service for a plurality of live channels;
provide an authorization list that includes an authorization status of each of the plurality of live channels;
update the content directory service to exclude unauthorized live channel information and to include only authorized live channel information of the plurality of live channels based on the authorization list; and
providing the updated content directory service to a display.

20. A non-transitory computer-readable medium having stored thereon a plurality of computer-executable instructions which, when executed by a computer, cause the computer to:
provide, by a set top box, a content directory service for a plurality of live channels;
provide an authorization list that includes an authorization status of each of the plurality of live channels;
update, by the set top box, the content directory service to exclude unauthorized live channel information and to include only authorized live channel information of the plurality of live channels based on the authorization list; and
providing the updated content directory service to a display.

21. The method of claim 1, wherein the set top box is a digital media server in a Digital Living Network Alliance network.

22. The device of claim 19, wherein the set top box is a digital media server in a Digital Living Network Alliance network.

23. The non-transitory computer-readable medium of claim 20, wherein the set top box is a digital media server in a Digital Living Network Alliance network.
